(19) United States
(12) Patent Application Publication
(10) Pub. No.: US 2017/0091350 A1
(43) Pub. Date: Mar. 30, 2017

(54) NEAR REAL-TIME MODELING OF POLLUTION DISPERSION

(71) Applicants: Alexander BAUER, Darmstadt (DE); Marco HUBER, Weinheim (DE)

(72) Inventors: Alexander BAUER, Darmstadt (DE); Marco HUBER, Weinheim (DE)

(21) Appl. No.: 14/863,651

(22) Filed: Sep. 24, 2015

(51) Int. Cl. G06F 17/50

(52) U.S. Cl. CPC G06F 17/5009

(57) ABSTRACT

Methods and systems for computerized modeling of dispersion of pollution originating from vehicles travelling on a road network are provided. Traffic-related data for road segments useable to calculate a pollution emission estimate for the segments is captured and weather-related data for segments are obtained. A pollution emission estimate is calculated for each segment. Segments are associated with a pollution dispersion model based on a traffic flow label of the segment. A pollution density map is calculated based on the superpositions of segment dispersions. The pollution density map is updated in response to detecting changes affecting one or more segment dispersions.

### TECHNICAL FIELD

The presently disclosed subject matter relates generally to modeling pollution dispersion, and in particular, modeling atmospheric dispersion of pollution from vehicular traffic in near real-time.

### BACKGROUND

Air pollution is one of the major environmental challenges facing mankind today. In addition to harming the Earth's environment, air pollution has been shown to cause or contribute to respiratory diseases in humans including asthma, bronchitis and lung cancer. One of the major sources of air pollution in urban areas is vehicular traffic.

Vehicles emit pollutants such as CO, CO₂ and NOₓ, which exit the vehicle and are dispersed in the atmosphere by moving air. Many factors influence how the pollutants disperse in the atmosphere including traffic patterns, wind, atmospheric stability, topography of the local region and the nature and amount of the pollutants themselves. Predicting how pollution emitted at specific roadways is dispersed in the surrounding atmosphere is important in order to take appropriate corrective action. For example, city planners can use the information to influence the design of new roads or make changes to existing ones, and governments can issue warnings to city residents if particular areas of the city are expected to contain high pollution concentrations.

Various solutions to modelling pollution dispersion from vehicles have been proposed. These solutions typically rely on computerized traffic simulations to simulate traffic flow, or use receptors to measure the amount of atmospheric pollution at specific locations. For example:

Emad A. A., Sayed M. El Shazly, Kassem Kh. O. Computer Simulation for Dispersion of Air Pollution Released from a Line Source according to Gaussian Model. Canadian Journal on Computing in Mathematics, vol. 1, no. 3, pp. 77-85, April 2010, describes a line source model to describe the downwind dispersion of pollutants near roadways. The model is based on the Gaussian plume methodology and is used to predict air pollutants' concentrations near the roadways at a user specified receptor grid.

Liping Xia, Yaping Shao. Modelling of traffic flow and air pollution emission with application to Hong Kong Island. Environmental Modelling & Software, vol. 20, pp. 1175-1188, 2005, describes a Lagrangian model for the simulation of traffic flow on a complex road network using a traffic flow simulation model capable of simulating traffic flow on a road network. The simulated traffic flow is then used as the basis for the estimation of traffic induced emission of air pollutants. Using empirical emission factors for a number of vehicle categories, the emission rates of major air pollutants are estimated.

Brian Y. Kim, Predicting air quality near roadway intersections through the application of a Gaussian puff model to moving sources, Ph.D. Dissertation, Fall 2004, University of Central Florida, Dept. of Civ. and Env. Engineering, describes a simulation approach where the movement of each individual vehicle is modeled at an interrupted traffic scenario such as a signalized intersection. Thus, each vehicle is modeled as a discrete moving source with appropriate modal movements (e.g., acceleration, deceleration, etc.) and emissions during each simulation time-step. The emitted pollutants are modeled as a series of Gaussian puffs (i.e., rather than plumes) with one puff being emitted per vehicle for each time-step. Advection of each puff is accomplished through contributions from the mean wind, vehicle wake effects (dragging), and atmospheric rise (e.g., thermal buoyancy) of the vehicle exhaust gases. These same factors are also responsible for the dispersion (growth in sigma, u, values) of each puff. At preset time-intervals, merging of puffs based on a closeness criteria are conducted to prevent an unruly number of puffs from existing in a simulation. Concentrations are sampled during each time step such that the concentration at each receptor location is determined by summing the contributions from all existing puffs. After the simulation is complete, the sampled receptor concentrations are averaged over a selected time period to obtain the final concentrations at each receptor location.

User's Guide to CAL3QHC Version 2.0: A Modeling Methodology for Predicting Pollutant Concentrations near Roadway Intersections, US EPA, 1995, describes a microcomputer based model to predict carbon monoxide or other pollutant concentrations from motor vehicle at roadway intersections using a line source dispersion model and a traffic algorithm for estimating vehicular queue lengths at signalized intersections.

Another solution is described in Chinese Patent Publication No. 102289656, which discloses a method for calculating effect of traffic flow on city pollution by, inter alia, identifying the sizes of vehicles, wherein the sizes of the vehicles are classified based on the license plate color; setting emission factors according to the speeds of the vehicles; turning the factors into the identified or given different emission indexes of the vehicles to generate the concentration of exhaust dust and carbon monoxide (CO) of a road.

### GENERAL DESCRIPTION

Therefore, in accordance with certain aspects of the presently disclosed subject matter, there is provided a method of computerized modeling of dispersion of pollution originating from vehicles travelling on a road network comprising a plurality of road segments, the method comprising: capturing, using a combination of first sensors and second sensors monitoring the road network, traffic-related data for one or more first road segments in the plurality of road segments, wherein the traffic-related data for a given road segment is informative at least of data useable to calculate a pollution emission estimate for the given road segment; obtaining, in a memory, weather-related data for each road segment in the plurality of road segments; calculating, by a processor, a pollution emission estimate for each first road segment using the captured traffic-related data for each first road segment; associating each first road segment with a pollution dispersion model, wherein the pollution dispersion model associated with a given first road segment is selected from a plurality of pollution dispersion models in accordance with at least a traffic flow label of the given first road segment; calculating a pollution density map for a geographic area comprising the road network, the pollution density map indicative of pollution concentrations at a plurality of locations in the geographic area during a first time period, the pollution density map calculated based on the superpositions of segment dispersions calculated for each first road segment during the first time period, wherein the segment dispersion during a given time period for a given first road segment is calculated based at least in part on a pollution emission estimate calculated for the given first road segment during the given time period, the pollution dispersion model associated with the given first road segment during the given time period, and the obtained weather-related data for the given first road segment during the given time period.

In accordance with certain other aspects of the presently disclosed subject matter, there is provided a system for modeling the dispersion of pollution originating from vehicles travelling on a road network comprising a plurality of road segments, the system comprising: one or more sensors configured to monitor one or more first road segments and capture traffic-related data for the monitored first road segments informative at least of data useable to calculate a pollution emission estimate for each monitored first road segment; a memory; and a processor communicatively coupled to the one or more sensors and the memory, and configured to: obtain, from the memory, weather-related data for each road segment in the plurality of road segments; calculate, using the captured traffic-related data, a pollution emission estimate for each first road segment; associate each first road segment with a pollution dispersion model, wherein the pollution dispersion model associated with a given first road segment is selected from a plurality of pollution dispersion models in accordance with at least a traffic flow label of the given first road segment; and calculate a pollution density map for a geographic area comprising the road network, the pollution density map indicative of pollution concentrations at a plurality of locations in the geographic area during a first time period, the pollution density map calculated based on the superpositions of segment dispersions calculated for each first road segment during the first time period, wherein the segment dispersion during a given time period for a given first road segment is calculated based at least in part on a pollution emission estimate calculated for the given first road segment during the given time period, the pollution dispersion model associated with the given first road segment during the given time period, and the stored weather-related data for the given first road segment during the given time period.

In accordance with certain other aspects of the presently disclosed subject matter, there is provided a non-transitory storage medium comprising instructions that, when executed by a processor, cause the processor to: obtain data informative of a road network comprising a plurality of road segments; obtain traffic-related data for one or more first road segments in the plurality of road segments, wherein the traffic-related data for a given first road segment is captured by a combination of first sensors and second sensors monitoring the first road segment and is informative at least of data useable to calculate a pollution emission estimate for the given first road segment; obtain weather-related data for each road segment in the plurality of road segments; calculate, using the captured traffic-related data, a pollution emission estimate for each first road segment; associate each first road segment with a pollution dispersion model, wherein the pollution dispersion model associated with a given first road segment is selected from a plurality of pollution dispersion models in accordance with at least a traffic flow label of the given first road segment; and calculate a pollution density map for a geographic area comprising the road network, the pollution density map indicative of pollution concentrations at a plurality of locations in the geographic area during a first time period, the pollution density map calculated based on the superpositions of segment dispersions calculated for each first road segment during the first time period, wherein the segment dispersion during a given time period for a given first road segment is calculated based at least in part on a pollution emission estimate calculated for the given first road segment during the given time period, the pollution dispersion model associated with the given first road segment during the given time period, and the stored weather-related data for the given first road segment during the given time period.

In accordance with further aspects and, optionally, in combination with other aspects of the presently disclosed subject matter, topographical-related data for each road segment can be obtained, and the segment dispersion for a given road segment can be calculated based also at least in part on the topographical-related data for the given road segment.

In accordance with further aspects and, optionally, in combination with other aspects of the presently disclosed subject matter, traffic-related data for one or more second road segments in the plurality of road segments can be obtained, the traffic-related data for a given second road segment obtained by using spatial interpolation based at least in part on the traffic-related data obtained for at least one first road segment in proximity to the given second road segment. A pollution emission estimate for each second road segment can be calculated using the obtained traffic-related data for each second road segment. Each second road segment can be associated with a pollution dispersion model, wherein the pollution dispersion model associated with a given second road segment is selected from a plurality of pollution dispersion models in accordance with at least a traffic flow label of the given second road segment. A segment dispersion for each second road segment during the first time period can be calculated based at least in part on the pollution emission estimate calculated for the given second road segment during the first time period, the pollution dispersion model associated with the given second road segment during the first time period, and the obtained weather-related data for the given second road segment during the first time period. The pollution density map for the road network can be calculated based also on the superpositions of segment dispersions calculated for the second road segments during the first time period.

In accordance with further aspects and, optionally, in combination with other aspects of the presently disclosed subject matter, in response to detecting, during a second time period, a change greater than a threshold in at least one of: the weather-related data obtained for a first or second road segment, the traffic-related data captured for a first road segment or obtained for a second road segment, the pollution dispersion model associated with a first or second road segment, or the pollution emission estimate calculated for a first or second road segment, the segment dispersion for each road segment affected by the detected change can be recalculated, and the pollution density map can be updated based on the recalculated segment dispersions.

In accordance with further aspects and, optionally, in combination with other aspects of the presently disclosed subject matter, the traffic-related data for a given first road segment can include data informative of at least traffic speed, traffic density, and traffic composition at the given first road segment. The data informative of traffic speed can be provided by one or more first sensors monitoring the given first road segment, and the data informative of traffic composition can be provided by one or more second sensors monitoring the given first road segment. The one or more first sensors can be selected from the group consisting of induction loops, traffic cameras, license plate recognition (LPR) cameras, and sensors useable to obtain floating car data (FCD). The one or more second sensors can be LPR cameras.

In accordance with further aspects and, optionally, in combination with other aspects of the presently disclosed subject matter, the pollution dispersion model can be selected from the group consisting of: a Gaussian line source dispersion model, a Gaussian plume dispersion model, and a combination thereof. A given road segment can be associated with a first pollution dispersion model if traffic flow at the road segment is indicative of “stop and go” traffic, and a second pollution dispersion model different from the first pollution dispersion model if traffic flow at the given road segment is indicative of “flowing” traffic. At least one road segment can be assigned an initial traffic flow label based at least in part on expected traffic flow at the road segment, and subsequently the traffic flow label can be updated in response to actual traffic flow detected at the road segment.

In accordance with further aspects and, optionally, in combination with other aspects of the presently disclosed subject matter, the weather-related data can include at least wind direction and wind speed.

In accordance with further aspects and, optionally, in combination with other aspects of the presently disclosed subject matter, the pollution emission estimate for a given road segment can be calculated by: obtaining, using at least some of the traffic-related data for the given road segment, data informative of traffic speed at the first road segment and emission profiles for at least some of the vehicles driving on the first road segment, constructing an emission profile population histogram for the first road segment indicative of the distribution of emission profiles obtained for the first road segment, and calculating a pollution emission estimate for the first road segment based at least in part on the emission profile population histogram for the first road segment and the traffic-related data obtained for the first road segment.

As detailed herein, a main advantage of certain embodiments of the presently disclosed subject matter is the near real time analysis of pollution dispersion based on data obtained from sensors, including sensors of different types, and the specialized treatment of “stop and go” traffic.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a functional block diagram of a pollution dispersion modeling system in accordance with certain embodiments of the presently disclosed subject matter;

FIG. 2 is a generalized flow chart of calculating a pollution density map in accordance with certain embodiments of the presently disclosed subject matter;

FIG. 3 is a generalized flow chart of calculating a segment dispersion in accordance with certain embodiments of the presently disclosed subject matter;

FIG. 4 is a non-limiting example of a segment graph in accordance with certain embodiments of the presently disclosed subject matter; and

FIG. 5 is a non-limiting example of a pollution density map in accordance with certain embodiments of the presently disclosed subject matter.

### DETAILED DESCRIPTION OF EMBODIMENTS

The principles and operation of a system for near real time modeling of pollution dispersion according to the presently disclosed subject matter may be better understood with reference to the drawings and the accompanying description.

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “calculating”, “estimating”, “obtaining”, “updating”, “generating”, “determining”, “associating”, “storing” or the like, refer to the action(s) and/or process(es) of a computer that manipulate and/or transform data into other data, said data represented as physical, such as electronic, quantities and/or said data representing the physical objects. The term “computer” should be expansively construed to cover any kind of electronic device with data processing capabilities including, by way of non-limiting example, a processor, or other suitable parts of the computer-based pollution dispersion modeling system disclosed in the present application.

It is to be understood that the term “non-transitory” is used herein to exclude transitory, propagating signals, but to include, otherwise, any volatile or non-volatile computer memory technology suitable to the presently disclosed subject matter.

The operations in accordance with the teachings herein can be performed by a computer specially constructed for the desired purposes or by a general-purpose computer specially configured for the desired purpose by a computer program stored in a computer readable storage medium.

The references cited in the background teach many principles of modeling pollution dispersion that may be applicable to the presently disclosed subject matter. Therefore the full contents of these publications are incorporated by reference herein where appropriate for teachings of additional or alternative details, features and/or technical background.

Embodiments of the presently disclosed subject matter are not described with reference to any particular programming language. It will be appreciated that a variety of programming languages can be used to implement the teachings of the presently disclosed subject matter as described herein.

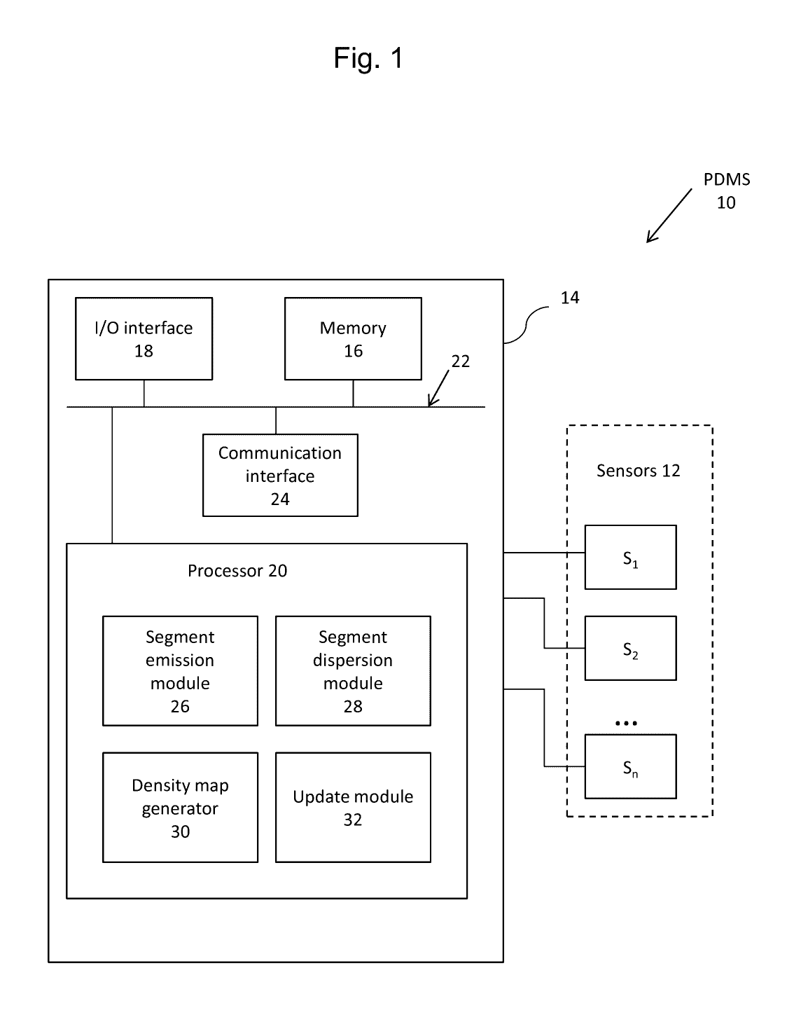

Bearing this in mind, attention is drawn to FIG. 1, where there is illustrated a generalized functional diagram of a Pollution Dispersion Modeling System (PDMS) 10. PDMS 10 includes a plurality of sensors 12 denoted as S₁, S₂ . . . Sₙ communicatively coupled to a processing unit 14. As used herein, the term “communicatively coupled” should be expansively construed to include all suitable forms of wired and/or wireless connections enabling the transfer of data between coupled components.

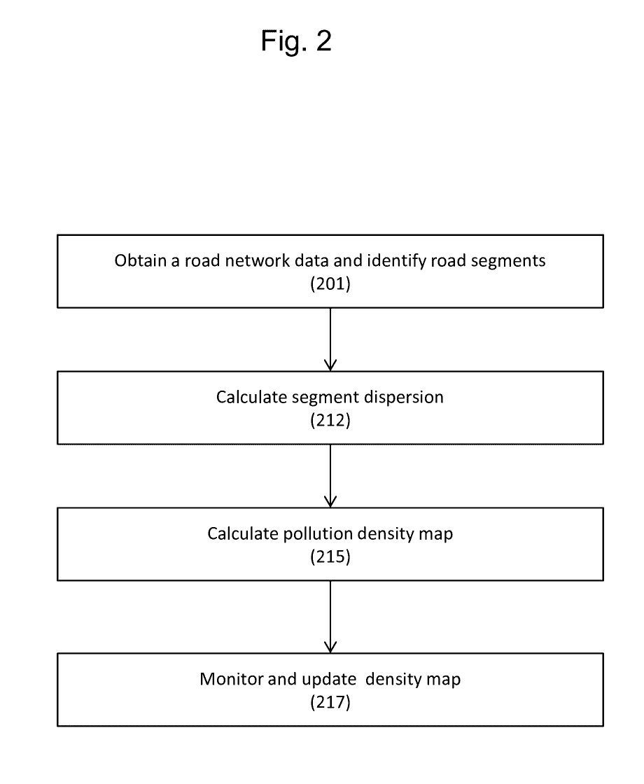

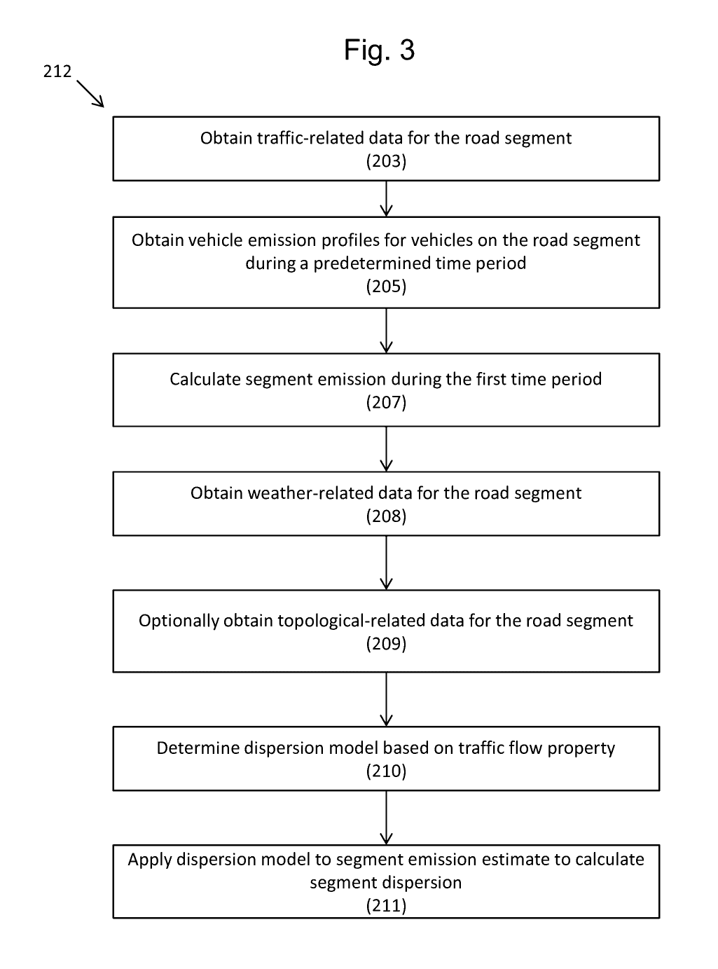

In certain embodiments, sensors 12 include one or more traffic sensors for capturing traffic-related data, as will be further detailed below with reference to FIGS. 2-3. By way of non-limiting example, sensors 12 can include license plate recognition (LPR) cameras, video cameras with traffic analytics, loop sensors, RADAR/LIDAR sensors, sensors useable for capturing floating car data (FCD) (e.g. cell phone towers for capturing FCD from mobile phones, radio-frequency identification (RFID) detectors for capturing FCD from RFID transponders, Bluetooth sensors for capturing FCD from Bluetooth devices, etc.), combinations thereof, etc.

In certain embodiments, processing unit 14 includes a memory 16, input/output (I/O) interface 18, processor 20, and communication interface 24 all communicatively coupled, e.g. via a communication bus 22.

Memory 16 can be, e.g. non-volatile computer readable memory, and is configured to store data captured by sensors 12, program data, and/or program instructions for performing the functions of the PDMS.

I/O interface 18 is configured to perform input/output operations enabling user interaction with the PDMS. I/O interface 18 can be connected to at least one input device such as a keyboard (not shown) and/or at least one output device such as a display (not shown).

Communication interface 24 is configured to perform send and receive operations enabling the PDMS to communicate with computer systems external to the PDMS, such as third party weather databases, vehicle registration databases, etc., as will be detailed with reference to FIGS. 2-3.

Processor 20 can be configured to execute several functional modules in accordance with computer-readable instructions implemented on a non-transitory computer usable medium. Such functional modules are referred to hereinafter as comprised (or included) in the processor. Processor 20 can include, in certain embodiments, such functional modules as a segment emission module 26 for calculating a road segment's emission estimate, segment dispersion module 28 for modeling a road segment's pollution dispersion, density map generator 30 for generating a pollution density map, and an update module 32 for performing near real-time or periodic updates to the pollution density map, as will be further detailed with reference to FIGS. 2-3.

It is noted that the teachings of the presently disclosed subject matter are not bound by the specific PDMS described with reference to FIG. 1. Equivalent and/or modified functionality can be consolidated or divided in another manner and can be implemented in any appropriate combination of software, firmware and hardware. The processing unit can be implemented as a suitably programmed computer. The functions of the processing unit can be, at least partially, integrated with one or more of sensors 12.

Referring now to FIG. 2, there is illustrated a generalized flow chart of calculating a pollution density map in accordance with certain embodiments of the presently disclosed subject matter.

Processor 20 obtains data informative of a road network (201) comprising one or more roads, and identifies at least some of the road segments comprised in the obtained road network, as will be detailed below. In certain embodiments, data informative of a road network can be loaded from memory 16. In certain other embodiments, data informative of a road network can be obtained from an external computer system (e.g. using communication interface 24), for example, a third party map source database (e.g. OpenStreetMap, etc.) accessible, e.g., via an application programming interface (API) (not shown).

As used herein, the term “road segment” should be expansively construed to cover a section of road bounded between two segment end points. As used herein, the term “segment end point” should be expansively construed to cover a section of a roadway that is either: monitored by a traffic sensor capable of providing vehicle identification (e.g. LPR camera), an intersection, or a road end point. As used herein, a “road end point” should be expansively construed to cover a section of roadway where a road ends without crossing or meeting another intersecting road. Non-limiting examples of a road end point include a “dead end”, a “cul de sac”, etc. It should be appreciated that any reference made herein to “LPR camera” is for illustrative purposes only, and it is to be understood that, unless context suggests otherwise, other types of sensors capable of providing vehicle identification data useable to obtain a vehicle emission profile can be used instead of LPR cameras.

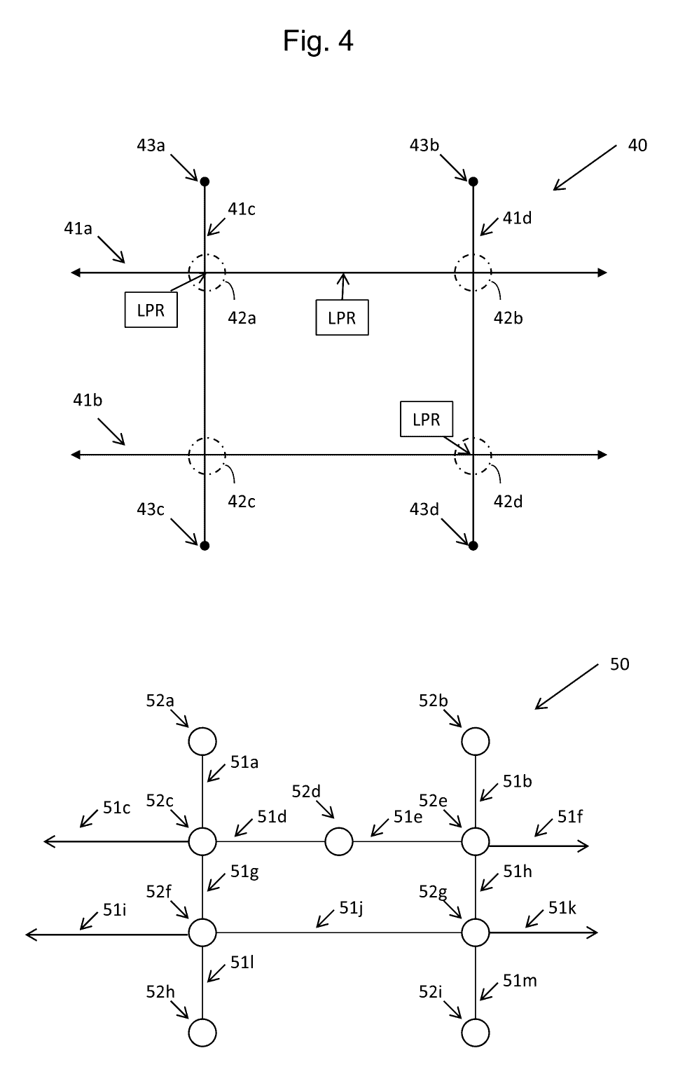

In certain embodiments, identifying road segments in the road network can include determining, in the road network, the locations of intersections, road end points, and monitored sections of roadway, monitored by LPR cameras. In certain embodiments, identifying road segments can further include segmenting a road monitored by an LPR camera into two road segments, as further detailed below with reference to FIG. 4.

In certain embodiments, at least some of the road segments comprised in the road network are monitored segments. As used herein, a “monitored segment” should be expansively construed to cover a road segment that is monitored by one or more traffic sensors 12. Some monitored segments can be monitored by one type of traffic sensor (e.g. loop detectors), while other monitored segments can be monitored by other types of traffic sensors (e.g. video cameras). Furthermore, a given monitored segment can be monitored by several traffic sensors, including traffic sensors of different types. Some other road segments can be “unmonitored”, i.e. not monitored by any traffic sensor.

In certain embodiments, identifying road segments can include constructing a segment graph. A segment graph can consist of nodes connected by undirected edges, where each pair of connected nodes represents end points of a respective segment, and the edges represent road segments. Each node can be associated with a location identifier, such as GPS coordinates, describing the geographic location of the segment end point represented by the node. Likewise, each edge can be associated with a string of location identifiers representing several points along the road segment represented by the edge. It should be appreciated that the string of location identifiers can be used to identify not only the geographic location of the points along the road segment, but also the shape of the respective segment, e.g. line, circular, etc. It should further be appreciated that if an LPR camera monitors an intersection or a road end point, a single node in the segment graph can be used to represent both the LPR camera-monitored area and the intersection/road end point. It will further be appreciated that the location identifier assigned to such a node provides the geographic location of both the LPR camera-monitored area and the intersection/road end point.

Referring now to FIG. 4, there is illustrated, by way of non-limiting example, a portion of a road network 40 including roads 41a-d, intersections 42a-d, and road end points 43a-d. LPR cameras are installed at, and monitor, intersections 42a, 42d and road 41a between intersections 42a and 42b. Segment graph 50 illustrates a segment graph which can be generated to represent road network 40. Segment graph 50 includes edges 51a-m representing road segments, and nodes 52a-i representing intersections, road end points, and LPR cameras. It should be noted that road 41a consists of two distinct road segments by virtue of there being an LPR camera positioned to monitor road 41a between intersections.

Next, for at least some of the road segments in the road network, processor 20 calculates the dispersion of pollutants (212) emitted at the road segment (“segment dispersion”), indicative of the concentration of one or more pollutants, emitted at the given road segment, at each of a plurality of locations in the geographical area covered by the road network, as will be further detailed below with reference to FIG. 3. As used herein, “calculating” should be expansively construed to cover estimating, predicting, modeling, and the like. In certain embodiments, processor 20 calculates the segment dispersion for all of the road segments in the obtained road network. In certain other embodiments, processor 20 calculates the segment dispersion for only a subset of the road segments in the road network. In certain embodiments, processor 20 can calculate a segment dispersion using, e.g. segment dispersion module 28.

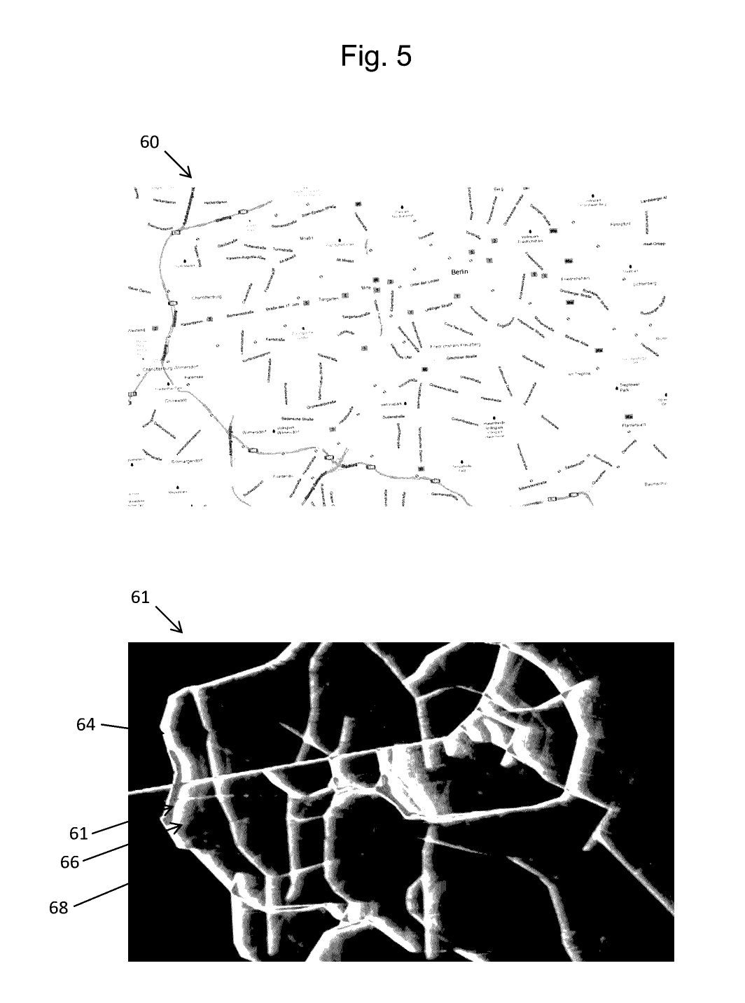

Processor 20 then calculates a pollution density map (215) for the geographical area covered by the road network, e.g. using density map generator 30, indicative of the concentration of one or more pollutants at each of a plurality of geographical locations, the one or more pollutants having been emitted at one or more road segments comprised in the road network. In certain embodiments, the pollution density map can be calculated by superposing, at each of the plurality of geographical locations, the pollution concentrations of one or more pollutants which are expected to be present at the geographical location based on the segment dispersions calculated in 212. In certain embodiments, the calculated pollution density map can be displayed graphically to an output device (e.g. using I/O interface 18), e.g. in the form of a contour map. Referring now to FIG. 5, there is illustrated an exemplary road network 60 in Berlin comprising a plurality of road segments, and a corresponding contour map 61 providing a graphical representation of the estimated concentrations of vehicular pollution in various areas of Berlin. In certain embodiments, different ranges of concentrations can be indicated graphically using a color scheme to differentiate different ranges. By way of non-limiting example, high pollution areas can be indicated by a first color 62 (e.g. red), medium pollution areas can be indicated by a second color 64 (e.g. yellow), low pollution areas can be indicated by a third color 66 (e.g. green), and zero or negligible pollution areas can be indicated by a fourth color 68 (e.g. black) or no color.

In certain embodiments, after calculating the pollution density map, processor 20 can monitor and update (217) the calculated pollution density map, e.g. using update module 32, in real-time or near real-time in response to detecting changes in the data associated with a road segment, as will be detailed below. Alternatively or in addition, processor 20 can update the calculated pollution density map at regular, predetermined intervals.

Referring now to FIG. 3, there is illustrated a generalized flow chart of calculating a segment dispersion for a given road segment in accordance with certain embodiments. Processor 20 obtains data (203) informative of one or more traffic-related parameters associated with the given road segment (“traffic-related data”) during a first predetermined time period. The traffic-related data for a given road segment can be obtained in different ways for different road segments, depending on whether the given road segment is a monitored segment or an unmonitored segment. If a given road segment is a monitored segment, some or all of the traffic-related data can be obtained, e.g., directly from the traffic sensors monitoring the given road segment which capture real-time traffic-related data. Alternatively, some or all of the traffic-related data can be obtained, e.g., from a memory communicatively coupled to the traffic sensors, the traffic-related data having been previously captured and stored in the memory.

On the other hand, if the given road segment is an unmonitored segment, some or all of the traffic-related data for the given road segment can, in some cases, be determined using techniques known in the art, e.g. using spatial interpolation based on the traffic-related data associated with other road segments, such as neighboring segments or linked road segments.

In certain embodiments, the traffic-related data for a given road segment includes data useable to calculate a pollution emission estimate for the given road segment, indicative of a rate of emission of one or more pollutants at the given road segment during a given time period. Traffic-related data useable to calculate a pollution emission estimate for a road segment can include, in some embodiments, data informative of traffic speed, density, and vehicle composition during the time period. Data informative of traffic speed can include, e.g., average traffic speed recorded during the time period or, e.g., specific vehicle speeds recorded for each of a plurality of vehicles travelling on the road segment during the time period. Data informative of traffic density can include, e.g., the number of vehicles occupying a certain road space at one time, e.g. number of vehicles per kilometer of road space. Data informative of vehicle composition can include, in certain embodiments, a number of vehicles. Preferably, data informative of vehicle composition also includes data useable to identify vehicles for the purpose of obtaining vehicle emission profiles for the vehicles driving on the road segment. Exemplary data useable to identify a vehicle includes, e.g., a vehicle license plate number, which can be captured, e.g., by an LPR camera, and run through a vehicle registration database to determine the vehicle type and associated emission profile, as will be detailed below.

In certain embodiments, at least some of the traffic-related data for at least some of the segments is obtained from one or more of traffic sensors 12. As detailed above, sensors 12 can include a combination of various different sensor types, including sensors of different types monitoring a single road segment. For example, a single road segment can be simultaneously monitored by an LPR camera providing vehicle composition data and by loop sensors providing speed and/or density data. Preferably, at least some road segments are monitored by LPR cameras. It should be noted that data informative of traffic density can, in certain embodiments, be obtained from one or more of traffic sensors 12 or, in certain other embodiments, can be calculated based on the number of passing vehicles during a certain time and average speed over the time period. See, e.g., Emad A. A., Sayed M. El Shazly, Kassem Kh. O. Computer Simulation for Dispersion of Air Pollution Released from a Line Source according to Gaussian Model. Canadian Journal on Computing in Mathematics, vol. 1, no. 3, pp. 77-85, April 2010.

Next, using the vehicle composition component of a monitored segment's traffic-related data, processor 20 obtains vehicle emission profiles (205) for each vehicle driving on the road segment during the first time period, and generates an emission profile population histogram for the segment, as will further be detailed herein. A vehicle emission profile is a set of mapping functions for determining the rate (e.g. in units of volume over time) of emission of specific pollutants at a given vehicle speed. In certain embodiments vehicle emission profiles can be obtained from external sources such as databases, e.g. using communication interface 24. In certain other embodiments, vehicle emission profiles can be obtained based on interpolation, as will be detailed below. In certain embodiments, vehicle emission profiles can be obtained for only a subset of the vehicles driving on the road segment, e.g. a random sampling of vehicles.

Processor 20 then calculates (207) for each segment, e.g. using segment emission module 26, a pollution emission estimate informative of an emission rate per pollutant for the segment (referred to herein as simply “segment emission”) during a certain time period. A segment's pollution emission estimate can be calculated as a function of the segment's emission profile population histogram (using the distribution of emission profiles and mapping functions contained therein), and the traffic-related data over the time period (e.g. traffic speed, traffic density, etc.). See, e.g., Emad A. A., Sayed M. El Shazly, Kassem Kh. O. Computer Simulation for Dispersion of Air Pollution Released from a Line Source according to Gaussian Model. Canadian Journal on Computing in Mathematics, vol. 1, no. 3, pp. 77-85, April 2010, for an exemplary formula for estimating emission. In certain embodiments, steps 203-207 detailed above can be performed using, e.g. segment emission module 26.

Processor 20 also obtains data (208) informative of current weather and atmospheric conditions (“weather-related data”) affecting the given road segment. In some cases, particularly when the size of the region covered by the road network is relatively small, each road segment may be associated with a single weather region. In such a case, the weather-related data can be obtained once and used for each road segment. In other cases, particularly for larger road networks, some road segments can be associated with a first weather region having first weather-related data, while other road segments can be associated with a second weather region having second weather-related data, and so on. In certain embodiments, each road segment can be associated with a weather region identifier which can be used to obtain the weather-related data characterizing the weather region associated with the given road segment. In certain embodiments, the weather region identifier can be a postal code, zip code, or any other weather region identifier. The weather-related data can be obtained at any point prior to calculating the segment dispersion.

In certain embodiments, the weather-related data includes at least wind speed, wind direction and atmospheric stability. Atmospheric stability data can include, e.g., data informative of Pasquill atmospheric class, Monin-Obukhov similarity theory metric, etc. See, e.g. Pasquill, F. (1961), The estimation of the dispersion of windborne material, The Meteorological Magazine, vol. 90, No. 1063, pp 33-49), and Monin, A. S., Obukhov, A. M. (1954), Basic laws of turbulent mixing in the surface layer of the atmosphere, Tr. Akad. Nauk SSSR Geofiz. Inst 24:163-187. Weather-related data for a given weather region can be obtained, e.g., from external computer systems using one or more data access protocols. Computerized sources of current weather-related data include, e.g., databases such as AccuWeather, Forecast.io, OpenWeatherMap, Yahoo Weather, etc.

In certain embodiments, processor 20 can also obtain data (209) informative of the topology of the given road segment (“topological-related data”). The topological-related data can include, e.g. data informative of the height of buildings, distance between buildings, surface terrain, elevation, etc. which can be used as further input to the pollution dispersion model. Topological-related data can be obtained from various external (e.g. using communication interface 24) sources including, e.g., Google Maps Elevation API, OpenStreetMap, etc. In certain embodiments, topological-related data can also be obtained from memory 16.

Next, processor 20 determines (210) a dispersion model to apply to a given road segment, as will further be detailed herein, and models the segment dispersion (211) using the segment emission estimate calculated for the given road segment, the pollution dispersion model associated with the given road segment, the weather-related data for the given road segment, and optionally the topological-related data for the given road segment.

As detailed above, in certain embodiments processor 20 obtains vehicle emission profiles and generates an emission profile population histogram for the segment. A vehicle emission profile for a vehicle on the road can be obtained, e.g., as follows. Using the license plate number obtained for the vehicle as part of the traffic-related data obtained for the segment in 203, a vehicle registration database can be queried for information about the type of vehicle associated with the obtained license plate number. Information about the type of vehicle can include generalized vehicle type information or specific vehicle type information, depending on the level of detail available from the vehicle registration database. Generalized vehicle type information includes at least general vehicle characteristics, non-limiting examples of which include, e.g. a vehicle category (e.g. car, truck, motorbike, etc.). Specific vehicle type information includes more detailed information including at least information about the vehicle's make, model, and year, and optionally other details as well. In certain embodiments, specific vehicle type information can also include a vehicle emission profile. However, if not, a vehicle emission profile can be determined based on the vehicle type information in other ways. For example, if the vehicle's make, model and year are known, an emission profile for the vehicle can, in certain cases, be looked up in a table of vehicles and their respective emission profiles. Otherwise, a vehicle's emission profile can be estimated based on the vehicle category. An emission profile for a vehicle on a road segment can alternatively be obtained in any other way known in the art.

In certain embodiments, the number of distinct vehicle emission profiles for a segment can be reduced to a relatively small number (e.g. 10 or less). If actual vehicle emission profiles are obtained based on specific vehicle type information, a clustering algorithm (e.g. k-means) can be used to reduce the number of profiles, in which case each vehicle can be associated with a representative emission profile rather than the vehicle's actual emission profile. The representative emission profile can be, e.g., the emission profile which best represents the cluster, e.g. the cluster centroid. If an estimate of the emission profile is used based on general vehicle characteristics, the estimated emission profile can be selected from a predefined list of a small number (e.g. 10 or less) of representative emission profiles which are representative of the spectrum of possible emission profiles.

As detailed above, in certain embodiments an emission profile population histogram for a road segment is constructed. The histogram represents the distribution of emission profiles associated with vehicles travelling on the segment during the first time period. In certain embodiments, it may be possible to obtain, in 203, precise information about the identity of vehicles on a given segment during a certain time period. For example, there can be LPR cameras covering every entry and exit point of a road segment (i.e. the nodes in the segment graph) such that the precise route of every vehicle travelling in the road network during the time period is known. In that case, once emission profiles for each vehicle on each segment are obtained, constructing an emission profile population histogram for each segment is trivial. However, in certain other embodiments, not every node is covered by an LPR camera, leading to less than perfect information about the composition of vehicles at each segment. In that case, emission profile population histograms can be constructed for all road segments (one histogram per segment) as follows:

1. Initialize each segment histogram to zero;

2. A predetermined time window, e.g. 1 hour, is selected, LPR detections of a given vehicle V_{ID} in the time window are recorded, and origin-destination node pairs are identified;

3. For each origin-destination node pair, an emission profile E(V_{ID}) is obtained for the vehicle, and the top N shortest paths between each origin-destination pair is determined, e.g. using the Dijkstra algorithm;

4. For each shortest path 1-N, the histogram associated with each edge along the path each edge's is updated by adding 1/N to the histogram count for emission profile E(V_{ID});

5. For road segments without LPR coverage, a spatial interpolation mechanism can be used to estimate the vehicle population statistics. See, e.g. Shiode, Naru and Shiode, Shino, (2012) Street-level spatial interpolation using network-based IDW and ordinary kriging, Transactions in GIS, Volume 15 (Number 4), pp. 457-477 (ISSN 13611682), for a description of the Kriging method. Alternatively a Kernel Density Estimation can also be used. Parameters of the interpolation mechanism (Kernel width) can be estimated through leave-one-out-cross-validation.

As detailed above, in certain embodiments processor 20 can determine a dispersion model to apply to a given road segment. In certain embodiments, the dispersion model to apply to a given road segment can depend on traffic flow at the road segment. For example, the dispersion model to apply to any given road segment can depend on whether traffic flow at the road segment is determined to be, e.g., “stop and go” or “flowing”. In certain embodiments, a road segment can be associated with a traffic flow label indicative of actual or expected traffic flow at the road segment. In certain embodiments, the traffic flow label of a road segment can be set to an expected value based on static factors which are expected to affect traffic flow at the road segment, e.g., the road segment's proximity to intersections, cross-walks, etc. In certain embodiments, the traffic flow label can be assigned to a road segment based on actual data related to traffic flow at the road segment at any given time. For example, if the road segment is a monitored segment, data related to traffic flow can be obtained from sensors monitoring the road segment. For unmonitored segments, data related to traffic flow can be obtained using, e.g., interpolation based on the traffic flow of other road segments, such as road segments in proximity to the given road segment. In certain embodiments, an initial traffic flow can be assigned to a road segment based on expected traffic flow, and thereafter the traffic flow label can be updated based on actual traffic flow.

By way of non-limiting example, the traffic flow label of a given road segment can be set to a first predetermined value representing “stop and go” traffic if certain predetermined criteria are met. Exemplary criteria, can be, e.g. that at least one of the following is true:
1. At least one segment end point adjacent to the given road segment is a controlled intersection, controlled by way of traffic light, stop sign, or other indicator that requires, at least at times, vehicles approaching the indicator to slow down to less than, e.g., 5 km/h or to come to a complete stop;
2. The given road segment contains, or is adjacent to, an obstacle which can reasonably be expected to cause vehicles on the road segment to slow down to less than, e.g., 5 km/h, or come to a complete stop. By way of non-limiting example, an obstacle can include, e.g., a construction site, an accident, etc;
3. Traffic on the road segment is known (e.g. from sensors) or estimated (e.g. by interpolation) to be moving at an average speed of less than, e.g. 5 km/h.
   If none of the above criteria are met, the traffic flow label can be set to a second predetermined value representing, e.g. “flowing” traffic. It should be appreciated that the non-limiting examples provided above illustrate exemplary traffic flow labels and criteria for their assignment, and that additional and/or other traffic flow labels and/or criteria are also possible.

In certain embodiments, if the traffic flow label associated with a given road segment is indicative of flowing traffic, a Gaussian line source dispersion model can be used to model the dispersion for the given segment, whereas if the traffic flow label is indicative of “stop and go” traffic, a Gaussian plume dispersion model can be used to model the segment dispersion for “stop and go” segments, or alternatively a Gaussian puff dispersion model can be used. See, e.g. Brian Y. Kim, Predicting air quality near roadway intersections through the application of a Gaussian puff model to moving sources, Ph.D. Dissertation, Fall 2004.

In certain embodiments, a combination of Gaussian plume dispersion model and Gaussian line source dispersion model can be used to estimate segment dispersion for “stop and go” segments. By way of non-limiting example, the following equation can be used:

C(x,y,z)=C_{GP}(X,y,z)^{(1-v)}×C_{GLSM}(x,y,z)^{v}

where C (x,y,z) is the predicted pollution concentration at location (x,y,z);

C_{GP} is the prediction by the Gaussian plume model;

C_{GLSM} is the prediction by the Gaussian line source model; and

v is a normalized velocity. By way of non-limiting example, v can be calculated using the formula:

$$v = \frac{v\_a}{v\_max}$$

where v_a is the averaged velocity and v_max is the maximum allowed velocity for the segment. In certain embodiments, the legal speed limit for a road segment can be used for v_max.

As detailed above, processor 20 can model the segment dispersion, based inter alia on the dispersion model determined in 210. In certain embodiments, if the pollution dispersion model is a Gaussian line source dispersion model, the generalized Gaussian line source dispersion model can be modified to incorporate data indicative of specific wind direction (instead of arbitrary wind direction). For example, the generalized Gaussian line source dispersion model provides for integrating over infinitely many point sources along a line segment according to the formula:

$$C ( x , y , z ) = {\int }_{0}^{L} \frac{Q \cdot f \cdot g}{π \cdot u \cdot {σ}_{y} \cdot {σ}_{z}} d l$$

where Q is the line source emission strength/rate assumed constant along the line source, L is the length of the line, and l is an arbitrary line. Assuming that the line lies directly on the y-axis with its middle point directly on the origin and further assuming that the wind direction is parallel to the x-axis, the above integral can be solved to:

$$C ( x , y , z ) = \frac{Q}{2 \cdot π \cdot u \cdot {σ}_{y} \cdot {σ}_{z}} {e}^{\frac{- {z}^{2}}{2 {σ}_{y}^{2}}} \cdot [ erf ( \frac{y + L / 2}{\sqrt{2} {σ}_{y}} ) - erf ( \frac{y - L / 2}{\sqrt{2} {σ}_{y}} ) ] \qquad ( 1 )$$

where erf is the Gaussian error function and Q, u, σ_{y}, σ_{z} as in the point source model.

In order to incorporate data indicative of specific wind direction, a transform can be calculated as follows:
1. Rotate the coordinate system in order to reflect the arbitrary wind direction φ. In doing so, the line is rotated and the new line start point [x′ₛ,y′ₛ]^{T} (where T is the matrix transpose) and end point [x′ₑ,y′ₑ]^{T} are given by

$$[ \begin{matrix}{x}_{s}^{′} \\ {y}_{s}^{′}\end{matrix} ] = [ \begin{matrix}cos ( φ ) & - sin ( φ ) \\ sin ( φ ) & cos ( φ )\end{matrix} ] \cdot [ \begin{matrix}{x}_{s} \\ {y}_{s}\end{matrix} ] \\ [ \begin{matrix}{x}_{e}^{′} \\ {y}_{e}^{′}\end{matrix} ] = [ \begin{matrix}cos ( φ ) & - sin ( φ ) \\ sin ( φ ) & cos ( φ )\end{matrix} ] \cdot [ \begin{matrix}{x}_{e} \\ {y}_{e}\end{matrix} ]$$

2. Calculate length L′ of the projection of the line onto y-axis according to

L′=2·|y′ₛ−y̅|
where y̅=y′+½Δy, with Δy=y′ₑ−y′ₛ.
3. Rotate and shear the coordinate system. This calculation is shown here is exemplary for an arbitrary point [x,y]^{T}:

$$[ \begin{matrix}{x}^{′} \\ {y}^{′}\end{matrix} ] = [ \begin{matrix}1 & - Δ x / Δ y \\ 0 & 1\end{matrix} ] \cdot [ \begin{matrix}cos ( φ ) & - sin ( φ ) \\ sin ( φ ) & cos ( φ )\end{matrix} ] \cdot [ \begin{matrix}x - \overline{x} \\ y - \overline{y}\end{matrix} ]$$

where Δx and x̅ are calculated analogously to Δy and y̅, respectively. The coordinate z is not affected by these operations.
4. The transformed point [x′,y′,z]^{T} is then used in (1) instead of [x,y,z]^{T}.

As detailed above, in certain embodiments, processor 20 can monitor and update the pollution density map. In some embodiments, processor 20 can be configured to monitor and update the pollution density map by, e.g., for each road segment:
1. Storing the traffic-related data, weather-related data, and traffic flow property which was used to calculate the segment dispersion for the given road segment (“stored segment data”), each time the segment dispersion is calculated or recalculated and superposed on the pollution density map;
2. Obtaining real-time, near real-time or periodic updates to the traffic-related data, weather-related data, and traffic flow property associated with the given road segment (“new segment data”);
3. Comparing the new segment data to the saved segment data; and
4. Recalculating the segment dispersion for the given road segment if the new segment data is sufficiently different than the saved segment data;
5. Updating the pollution density map based on the recalculated segment dispersion by removing the superposed segment dispersion associated with the given road segment and instead superposing the recalculated segment dispersion.

In certain embodiments, the new segment data is sufficiently different than the saved segment data if at least one of the following holds true:
1. The traffic flow label of the given road segment changed from “stop and go” to “flowing” or vice versa;
2. At least one of: traffic speed, traffic density, wind speed, and atmospheric stability increased or decreased more than a predetermined threshold;
3. The wind direction angle relative to the road segment changed by more than a predetermined threshold;
4. The segment emission estimate based on the new segment data is higher or lower than the segment emission based on the saved segment data by more than a predetermined threshold.

It should be appreciated that in some cases, recalculating the segment dispersion involves first recalculating the segment emission estimate, while in other cases it may not be necessary to recalculate the segment emission estimate, e.g. in cases where the only change detected was to the road segment's weather-related data.

It is to be understood that the presently disclosed subject matter is not limited in its application to the details set forth in the description contained herein or illustrated in the drawings. The presently disclosed subject matter is capable of other embodiments and of being practiced and carried out in various ways.

In embodiments of the presently disclosed subject matter, fewer, more and/or different stages than those shown in FIGS. 2-3 may be executed. In embodiments of the presently disclosed subject matter one or more stages illustrated in FIGS. 2-3 may be executed in a different order and/or one or more groups of stages may be executed simultaneously. FIG. 1 illustrates a general schematic of the system architecture in accordance with an embodiment of the presently disclosed subject matter. The modules in FIG. 1 can be made up of any appropriate combination of software, hardware and/or firmware that performs the functions as defined and explained herein. The modules in FIG. 1 can be centralized in one location or dispersed over more than one location. In other embodiments of the presently disclosed subject matter, the system can comprise fewer, more, and/or different modules than those shown in FIG. 1.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the presently disclosed subject matter as hereinbefore described without departing from its scope, defined in and by the appended claims.

1. A method of computerized modeling of dispersion of pollution originating from vehicles travelling on a road network comprising a plurality of road segments, the method comprising:
capturing, using a combination of first sensors and second sensors monitoring the road network, traffic-related data for one or more first road segments in the plurality of road segments, wherein the traffic-related data for a given road segment is informative at least of data useable to calculate a pollution emission estimate for the given road segment;
obtaining, in a memory, weather-related data for each road segment in the plurality of road segments;
calculating, by a processor, a pollution emission estimate for each first road segment using the captured traffic-related data for each first road segment;
associating each first road segment with a pollution dispersion model, wherein the pollution dispersion model associated with a given first road segment is selected from a plurality of pollution dispersion models in accordance with at least a traffic flow label of the given first road segment;
calculating a pollution density map for a geographic area comprising the road network, the pollution density map indicative of pollution concentrations at a plurality of locations in the geographic area during a first time period, the pollution density map calculated based on the superpositions of segment dispersions calculated for each first road segment during the first time period, wherein the segment dispersion during a given time period for a given first road segment is calculated based at least in part on a pollution emission estimate calculated for the given first road segment during the given time period, the pollution dispersion model associated with the given first road segment during the given time period, and the obtained weather-related data for the given first road segment during the given time period.

2. The method of claim 1, further comprising obtaining, in a memory, topographical-related data for each road segment, wherein the segment dispersion for a given road segment is calculated based also at least in part on the topographical-related data for the given road segment.

3. The method of claim 1, further comprising:
obtaining traffic-related data for one or more second road segments in the plurality of road segments, the traffic-related data for a given second road segment obtained by using spatial interpolation based at least in part on the traffic-related data obtained for at least one first road segment in proximity to the given second road segment;
calculating, by the processor, a pollution emission estimate for each second road segment using the obtained traffic-related data for each second road segment; and
associating each second road segment with a pollution dispersion model, wherein the pollution dispersion model associated with a given second road segment is selected from a plurality of pollution dispersion models in accordance with at least a traffic flow label of the given second road segment; and
calculating a segment dispersion for each second road segment during the first time period based at least in part on the pollution emission estimate calculated for the given second road segment during the first time period, the pollution dispersion model associated with the given second road segment during the first time period, and the obtained weather-related data for the given second road segment during the first time period;
wherein the pollution density map for the road network is calculated based also on the superpositions of segment dispersions calculated for the second road segments during the first time period.

4. The method of claim 3, further comprising: in response to detecting, during a second time period, a change greater than a threshold in at least one of:
the weather-related data obtained for a first or second road segment,
the traffic-related data captured for a first road segment or obtained for a second road segment,
the pollution dispersion model associated with a first or second road segment, or
the pollution emission estimate calculated for a first or second road segment,
recalculating the segment dispersion for each road segment affected by the detected change, and updating the pollution density map based on the recalculated segment dispersions.

5. The method of claim 1, wherein the traffic-related data for a given first road segment includes data informative of at least traffic speed, traffic density, and traffic composition at the given first road segment,
wherein the data informative of traffic speed is provided by one or more first sensors monitoring the given first road segment, and the data informative of traffic composition is provided by one or more second sensors monitoring the given first road segment,
wherein the one or more first sensors are selected from the group consisting of induction loops, traffic cameras, license plate recognition (LPR) cameras, and sensors useable to obtain floating car data (FCD), and
wherein the one or more second sensors are LPR cameras.

6. The method of claim 1, wherein the pollution dispersion model is selected from the group consisting of: a Gaussian line source dispersion model, a Gaussian plume dispersion model, and a combination thereof,
wherein a given road segment is associated with a first pollution dispersion model if traffic flow at the road segment is indicative of “stop and go” traffic, and a second pollution dispersion model different from the first pollution dispersion model if traffic flow at the given road segment is indicative of “flowing” traffic.

7. The method of claim 6, wherein at least one road segment is assigned an initial traffic flow label based at least in part on expected traffic flow at the road segment, and subsequently the traffic flow label is updated in response to actual traffic flow detected at the road segment.

8. The method of claim 1, wherein the weather-related data includes at least wind direction and wind speed.

9. The method of claim 1, wherein the pollution emission estimate for a given road segment is calculated by:
obtaining, using at least some of the traffic-related data for the given road segment, data informative of traffic speed at the first road segment and emission profiles for at least some of the vehicles driving on the first road segment,
constructing an emission profile population histogram for the first road segment indicative of the distribution of emission profiles obtained for the first road segment, and
calculating a pollution emission estimate for the first road segment based at least in part on the emission profile population histogram for the first road segment and the traffic-related data obtained for the first road segment.

10. A system for modeling the dispersion of pollution originating from vehicles travelling on a road network comprising a plurality of road segments, the system comprising:
one or more sensors configured to monitor one or more first road segments and capture traffic-related data for the monitored first road segments informative at least of data useable to calculate a pollution emission estimate for each monitored first road segment,
a memory, and
a processor communicatively coupled to the one or more sensors and the memory, and configured to:
obtain, from the memory, weather-related data for each road segment in the plurality of road segments;
calculate, using the captured traffic-related data, a pollution emission estimate for each first road segment;
associate each first road segment with a pollution dispersion model, wherein the pollution dispersion model associated with a given first road segment is selected from a plurality of pollution dispersion models in accordance with at least a traffic flow label of the given first road segment; and
calculate a pollution density map for a geographic area comprising the road network, the pollution density map indicative of pollution concentrations at a plurality of locations in the geographic area during a first time period, the pollution density map calculated based on the superpositions of segment dispersions calculated for each first road segment during the first time period,
wherein the segment dispersion during a given time period for a given first road segment is calculated based at least in part on a pollution emission estimate calculated for the given first road segment during the given time period, the pollution dispersion model associated with the given first road segment during the given time period, and the stored weather-related data for the given first road segment during the given time period.

11. The system of claim 10, wherein the processor is further configured to obtain, in the memory, topographical-related data for each road segment, wherein the segment dispersion for a given road segment is calculated based also at least in part on the topographical-related data for the given road segment.

12. The system of claim 10, wherein the processor is further configured to:
obtain traffic-related data for one or more second road segments in the plurality of road segments, the traffic-related data for a given second road segment obtained by using spatial interpolation based at least in part on the traffic-related data obtained for at least one first road segment in proximity to the given second road segment;
calculate a pollution emission estimate for each second road segment using the obtained traffic-related data for each second road segment; and
associate each second road segment with a pollution dispersion model, wherein the pollution dispersion model associated with a given second road segment is selected from a plurality of pollution dispersion models in accordance with at least a traffic flow label of the given second road segment; and
calculate a segment dispersion for each second road segment during the first time period based at least in part on the pollution emission estimate calculated for the given second road segment during the first time period, the pollution dispersion model associated with the given second road segment during the first time period, and the obtained weather-related data for the given second road segment during the first time period;
wherein the pollution density map for the road network is calculated based also on the superpositions of segment dispersions calculated for the second road segments during the first time period.

13. The system of claim 10, wherein the processor is further configured to:
detect, during a second time period, a change greater than a threshold in at least one of the weather-related data obtained for a first or second road segment, the traffic-related data captured for a first road segment or obtained for a second road segment, the pollution dispersion model associated with a first or second road segment, or the pollution emission estimate calculated for a first or second road segment, and, in response to said detecting,
recalculate the segment dispersion for each road segment affected by the detected change, and updating the pollution density map based on the recalculated segment dispersions.

14. The system of claim 10, wherein the traffic-related data for a given first road segment includes data informative of at least traffic speed, traffic density, and traffic composition at the given first road segment,
wherein the data informative of traffic speed is provided by one or more first sensors monitoring the given first road segment, and the data informative of traffic composition is provided by one or more second sensors monitoring the given first road segment,
wherein the one or more first sensors are selected from the group consisting of induction loops, traffic cameras, license plate recognition (LPR) cameras, and sensors useable to obtain floating car data (FCD), and
wherein the one or more second sensors are LPR cameras.

15. The system of claim 10, wherein the pollution dispersion model is selected from the group consisting of: a Gaussian line source dispersion model, a Gaussian plume dispersion model, and a combination thereof,
wherein the processor is configured to associate a given road segment with a first pollution dispersion model if traffic flow at the road segment is indicative of “stop and go” traffic, and a second pollution dispersion model different from the first pollution dispersion model if traffic flow at the given road segment is indicative of “flowing” traffic.

16. The system of claim 15, wherein at least one road segment is assigned an initial traffic flow label based at least in part on expected traffic flow at the road segment, and subsequently the traffic flow label is updated in response to actual traffic flow detected at the road segment.

17. The system of claim 10, wherein the weather-related data includes at least wind direction and wind speed.

18. The system of claim 10, wherein the processor is configured to calculate the pollution emission estimate for a given road segment by:
obtaining, using at least some of the traffic-related data for the given road segment, data informative of traffic speed at the first road segment and emission profiles for at least some of the vehicles driving on the first road segment, constructing an emission profile population histogram for the first road segment indicative of the distribution of emission profiles obtained for the first road segment, and
calculating a pollution emission estimate for the first road segment based at least in part on the emission profile population histogram for the first road segment and the traffic-related data obtained for the first road segment.

19. A non-transitory storage medium comprising instructions that when executed by a processor, cause the processor to:
obtain data informative of a road network comprising a plurality of road segments;
obtain traffic-related data for one or more first road segments in the plurality of road segments, wherein the traffic-related data for a given first road segment is captured by a combination of first sensors and second sensors monitoring the first road segment and is informative at least of data useable to calculate a pollution emission estimate for the given first road segment;
obtain weather-related data for each road segment in the plurality of road segments;
calculate, using the captured traffic-related data, a pollution emission estimate for each first road segment;
associate each first road segment with a pollution dispersion model, wherein the pollution dispersion model associated with a given first road segment is selected from a plurality of pollution dispersion models in accordance with at least a traffic flow label of the given first road segment; and
calculate a pollution density map for a geographic area comprising the road network, the pollution density map indicative of pollution concentrations at a plurality of locations in the geographic area during a first time period, the pollution density map calculated based on the superpositions of segment dispersions calculated for each first road segment during the first time period,
wherein the segment dispersion during a given time period for a given first road segment is calculated based at least in part on a pollution emission estimate calculated for the given first road segment during the given time period, the pollution dispersion model associated with the given first road segment during the given time period, and the stored weather-related data for the given first road segment during the given time period.

20. The medium of claim 17, further comprising instructions that when executed by the processor cause the processor to:
obtain traffic-related data for one or more second road segments in the plurality of road segments, the traffic-related data for a given second road segment obtained by using spatial interpolation based at least in part on the traffic-related data obtained for at least one first road segment in proximity to the given second road segment;
calculate a pollution emission estimate for each second road segment using the obtained traffic-related data for each second road segment; and
associate each second road segment with a pollution dispersion model, wherein the pollution dispersion model associated with a given second road segment is selected from a plurality of pollution dispersion models in accordance with at least a traffic flow label of the given second road segment; and
calculate a segment dispersion for each second road segment during the first time period based at least in part on the pollution emission estimate calculated for the given second road segment during the first time period, the pollution dispersion model associated with the given second road segment during the first time period, and the obtained weather-related data for the given second road segment during the first time period;
wherein the pollution density map for the road network is calculated based also on the superpositions of segment dispersions calculated for the second road segments during the first time period.
